(19) United States
(12) Patent Application Publication
(10) Pub. No.: US 2019/0121375 A1
(43) Pub. Date: Apr. 25, 2019

(54) HARVESTING ENERGY FROM PRESSURE DROP OF FUEL GAS

(71) Applicant: Natural Gas Solutions North America, LLC, Houston, TX (US)

(72) Inventor: Robert Erling Fowler, Houston, TX (US)

(21) Appl. No.: 15/793,679

(22) Filed: Oct. 25, 2017

(51) Int. Cl. G05D 16/20; F16K 31/06; G05D 7/06

(52) U.S. Cl. CPC G05D 16/2093; G05D 7/0629; F16K 31/0675

(57) ABSTRACT

A flow modulator generates energy concomitantly with pressure drop in a flowing fluid. The flow modulator may include a pipe section have a peripheral wall forming a bore and flanges on either end, a flow control disposed on the pipe section, the flow control comprising a first part and a second part, the first part disposed in the bore and the second part coupled with the peripheral wall to remain stationary relative to the first part. In one implementation, the first part generates a field to stimulate the second part to generate an electrical signal.

### BACKGROUND

Systems that carry flowing fluids often require pressure of the fluid to drop or reduce from an upstream pressure to a downstream pressure. The pressure drop may serve to condition the fluid for other parts of the system, like branch networks or metrology hardware found on gas distribution systems. Pressure regulators enjoys wide use for this purpose. These devices often leverage “mechanically-actuated” restrictions to generate the pressure drop. Such restrictions are effective to restrict the flow of fluid so as to reduce pressure from the higher, upstream pressure to the lower, downstream pressure.

### SUMMARY

The subject matter of this disclosure improves pressure regulators and like devices that decrease (or regulate) pressure of fluid. Of particular interest here are embodiments that can generate power concomitantly with pressure drop as well. The embodiments can incorporate into gas distribution networks. Electrical couplings can direct the power to nearby metrology hardware or other peripheral devices (e.g., batteries, lights, cameras, communication systems, etc.). For gas distribution, this feature may solve power limitations that resonate at installations in the field. These installations often use batteries or on-board storage to address the lack readily available, reliable, or consistent power. Power from the embodiments here may find use to energize electronic components or to replace, supplement, or charge the batteries. Use of the embodiments may also reduce duty cycle on batteries (or like energy supply found on-board the gas meter). This feature may preclude maintenance necessary to check and replace batteries, potentially saving significant costs because these installations may number in the hundreds and thousands in the field and, moreover, often reside in remote areas, both of which may present major logistical challenges to plan and allocate labor. It is also thought that supplemental power from the embodiments may improve reliability because it will avoid downtime of the gas meter should batteries die unexpectedly or suffer from reduced or total loss of energy prematurely, which can be significant nuisance and unplanned expense for the operator.

### DRAWINGS

Reference is now made briefly to the accompanying figures, in which:

FIG. 1 depicts a schematic diagram of an exemplary embodiment of an flow modulator;

FIG. 2 depicts a schematic diagram of the flow modulator of FIG. 1;

FIG. 3 depicts a schematic diagram of the flow modulator of FIG. 1 as part of a gas distribution network;

FIG. 4 depicts a schematic diagram of the flow modulator of FIG. 1 as part of a gas distribution network;

FIG. 5 depicts an elevation view of the cross-section from the side of an example of the flow modulator of FIG. 1;

FIG. 6 depicts an elevation view of the cross-section from the front of the flow modulator of FIG. 5;

FIG. 7 depicts an elevation view of the cross-section from the front of the flow modulator of FIG. 5;

FIG. 8 depicts an elevation view of exemplary structure for the flow modulator of FIG. 5;

FIG. 9 depicts a perspective view of the example of FIG. 8;

FIG. 10 depicts an elevation view of exemplary structure for the flow modulator of FIG. 5; and

FIG. 11 depicts an elevation view of the cross-section from the side of the flow modulator of FIG. 5.

Where applicable like reference characters designate identical or corresponding components and units throughout the several views, which are not to scale unless otherwise indicated. The embodiments disclosed herein may include elements that appear in one or more of the several views or in combinations of the several views. Moreover, methods are exemplary only and may be modified by, for example, reordering, adding, removing, and/or altering the individual stages.

### DETAILED DESCRIPTION

The discussion below describes embodiments of a flow modulator that can modulate flow of fluids. The embodiments include operative components that can provide fuel gas to gas meters (and related metrology hardware) at appropriate flow parameters. These components may, for example, operate to reduce pressure of the fuel gas from higher pressure consistent with well-head or large distribution pipelines to lower pressure that allows the gas meter to accurately quantify volumetric flow. As an added benefit, these same components may concomitantly generate power, effectively to reclaim energy from the drop in pressure of the fuel gas that flows through the flow modulator. Other embodiments are within the scope of the subject matter of this disclosure.

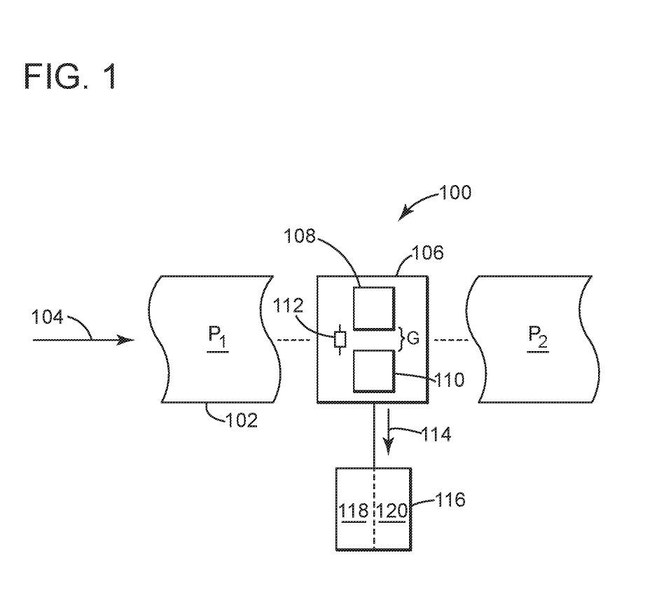

FIG. 1 depicts a schematic diagram of an exemplary embodiment of a flow modulator 100. This embodiment couples with a conduit 102 that carries material 104. Examples of material 104 may be fluids, solids, or fluid/solid mixes; for purposes of the discussion here, material 104 may be fuel gas. As also shown, the flow modulator 100 may form an energy transfer loop having a flow control 106 with components (e.g., a first component 108 and a second component 110) that are moveable relative to one another. An energy transitory mechanism 112 couples the components 108, 110 together across a gap G to generate a signal 114 in response to flow of material 104. The signal 114 may embody an electrical signal (e.g., current or voltage). In one implementation, the energy transfer loop may include a load circuit 116 that couples with the flow control 106. The load circuit 116 may include a load control 118 that couples with a load 120, for example, devices with electrical components that require power or provide storage. In operation, the load 120 defines an amount of energy (e.g., signal 114) drawn from the flow control 106, which in turn sets mechanical resistance to flow of material 104 to cause a pressure drop across the device, for example, as between a first pressure P₁ upstream of the flow control 106 to a second pressure P₂ downstream of the flow control 106.

Broadly, the flow modulator 100 is configured to reduce pressure of material 104 concomitantly with mechanical resistance to the flow. As noted, practice to date typically leverages “mechanically-actuated” restrictions to generate the pressure drop in the flow of material 106. The proposed design improves on these practices because it effectively “recovers” energy (as the signal 114) that results from the pressure drop. This energy may find use to power or supplement power on the load 120 or some other peripheral device. Examples of these devices include flow devices, like gas meters, batteries, lights, cameras, data systems, communication systems, and the like. In one implementation, the energy transfer loop may also use the signal 114 to generate quantifiable values for flow parameters (e.g., flow rate, pressure, etc.). Other values may correlate to movement of the components 110, 112, for example, rotation speed that occurs in response to flow of material 104.

The flow control 106 may be configured to interact with flow of material 104. These configurations may take the place of “mechanically-actuated” pressure regulators or like devices. Preference may be given to structure for the flow control 106 that interfere little with fluid dynamics of material 104. This structure may maintain the gap G that separates the components 108, 110, which is effective to reduce running friction or other interference that may add unwanted perturbations to the flow. This feature may prove useful because it won't introduce errors downstream when the flow modulator 100 is used in conjunction with metrology hardware that meters the flow of material 104.

The first component 108 may reside in the flow of material 104. It may adopt structure that can move (e.g., rotate) as material 104 passes across the device. Turbines and like “bladed” devices may be particularly well-suited for this endeavor. This structure may comprise metals, composites, or plastics, but this listing is not exhaustive. Preference may be given to materials that are compatible with material 104 to avoid corrosion or degradation. However, this disclosure does contemplate that other structure and materials may be useful as well.

The second component 110 may be configured to reside outside of the flow of material 104. In this position, the second component 110 may remain stationary (relative to the “moving” first component 108). It may also benefit installation, then, to fashion the second component 110 to avoid interference that can interrupt, e.g., rotation of the first component 110. However, this disclosure does contemplate some implementations where the second component 110 may transit to close any gap or distance with the first component 108.

The energy transitory mechanism 112 may be configured to transfer energy between the components 108, 110. These configurations may use structure that preserves the gap G between the components 108, 110. Preference may be given to “non-contact” modalities for this purpose. Exemplary modalities include magnetic or ultrasonic technologies, but this disclosure also contemplates that technologies developed after the date of this writing may also suffice.

The load circuit 116 may be configured to regulate the pressure drop across the flow control 106. These configurations may include circuitry that embodies the load control 118 to modulate the load 120 on the flow control 106. This circuitry may function to manage the energy drawn by the load 120 to appropriately impede relative movement between the components 108, 110. These functions, in turn, may cause pressure drop across the device to provide material 104 at appropriate pressure that is required downstream of the flow control 106. The circuitry may benefit from feedback, for example, sensors disposed in the flow of material 104 that monitor pressure upstream and downstream of the flow control 106.

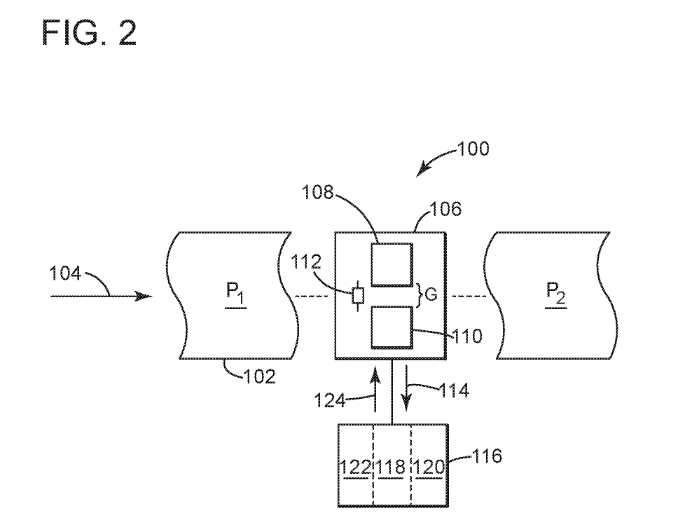

FIG. 2 depicts the flow modulator 100 of FIG. 1 with additional components to inform the following discussion. Here, the load circuit 116 may also include a source 122 that generates a signal 124, also an electrical signal like current or voltage. The signal 124 may impinge on the flow control 106 to impede relative movement between components 108, 110.

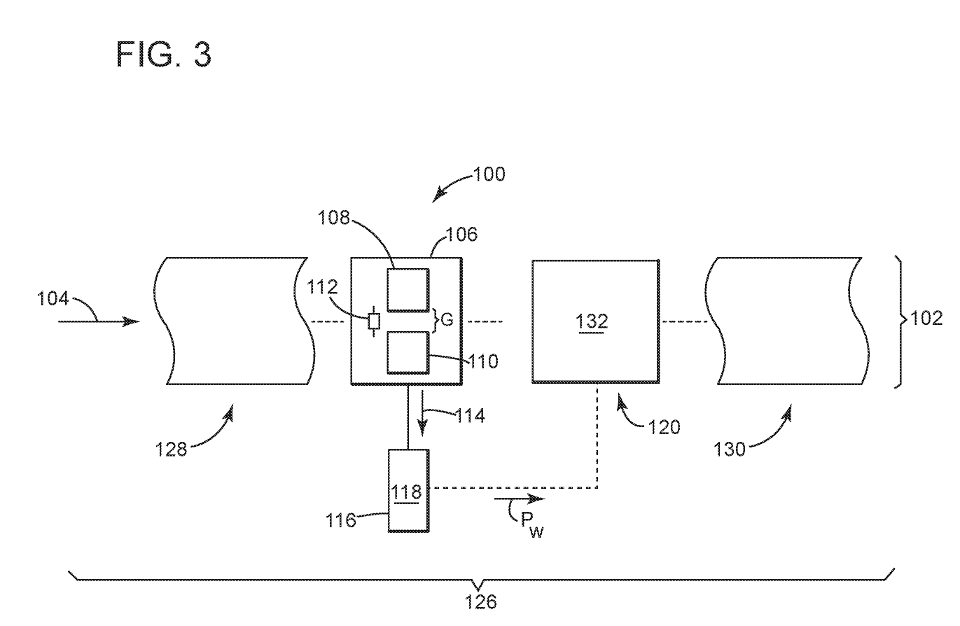

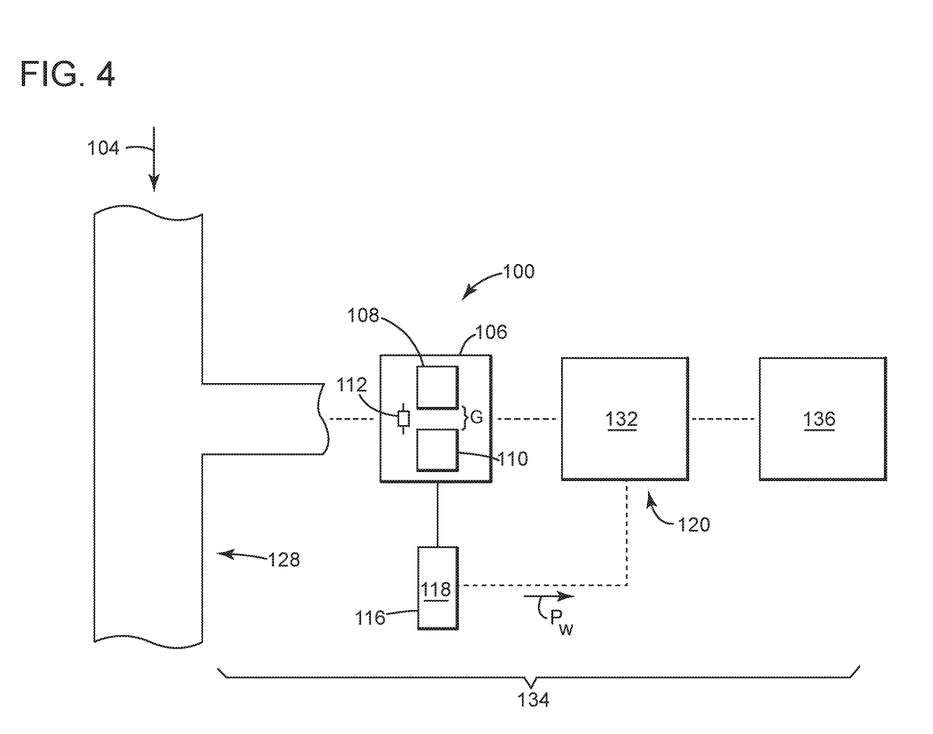

FIGS. 3 and 4 depict, schematically, various implementations of the flow modulator 100. In FIG. 3, the flow modulator 100 installs as part of a gas distribution network, identified generally by the numeral 126. The conduit 102 may include a high pressure line 128 and a low pressure line 130. Examples of lines 128, 130 may couple with a well-head installation or at other locations where fluid transits pipe and pipelines from high pressure to low pressure. A gas meter 132 may reside upstream of the low pressure line 130. In operation, the load control 118 may direct the signal 114 as power Pw to the gas meter 132. Notably, the gas meter 132 may operate as the load 120, as shown; but alternatives may have load 120 separate from any powered device(s), like the gas meter 132. As best shown in FIG. 4, the low pressure line 130 may form a branch 134 that terminates at, for example, a customer 136.

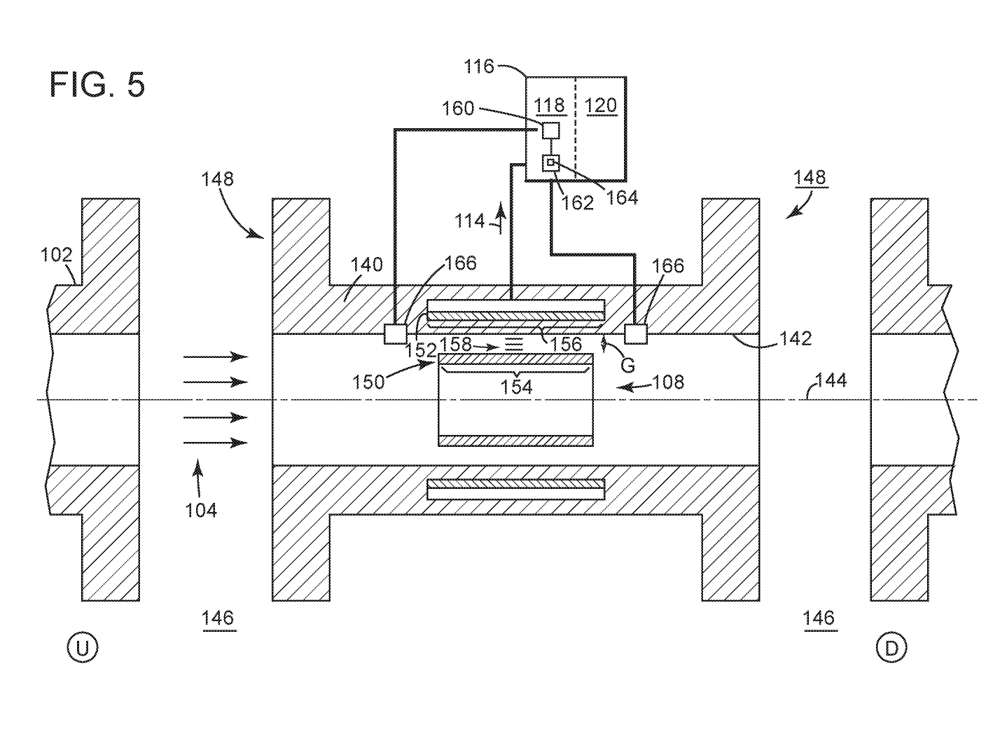

FIG. 5 depicts an elevation view of the cross-section of the front of exemplary structure for the flow modulator 100. The structure may include a body 138, for example, a pipe section with a peripheral wall 140 that circumscribes a bore 142 with an axis 144. The bore 142 may create openings at either end 146 of the pipe section. Flanges 148 at the ends 146 may mate with complimentary structure on exposed parts of the conduit 102, shown here as upstream part U and downstream part D. Fasteners like bolts may be useful to securely connect the parts to create a fluid-tight seal between flanges 148 and parts U, D. The first component 108 may locate inside of the bore 142, creating the gap G with the surface of the bore 142. The second component 110 may be disposed on or integrate as part of the peripheral wall 140. The energy transitory mechanism 112 may comprise two parts (e.g., a first part 150 and a second part 152). The first part 150 may correspond with a field generating region 154 on the first component 108. The second part 152 may correspond with an excitable region 156 on the second component 110. The field generating region 154 may generate a field 158 that excites the excitable region 156 to generate the signal 114. For additional functionality, the load control 120 may include computing components (e.g., processor 160 and memory 162 with executable instructions 164 stored thereon). The load circuit 116 may also include sensors 166, shown here disposed on the peripheral wall 140. Examples of the sensors 166 may operate to measure parameters (e.g., pressure, temperature, etc.) of material 104 in the bore 142. The sensors 166 may also find use to collect data on ambient conditions (e.g., temperature, relative humidity, etc.) that prevail in proximity to the pipe section as well.

The peripheral wall 140 may be configured for the pipe section to replicate part of the conduit 102. This configuration may help with installation, particularly to retrofit the device into existing pipes and pipelines in the field. In one implementation, a technician may remove part of an existing pipe. The technician may then install the pipe section in position to replace the missing section of the pipe. The load circuit 116 may connect to the pipe section, for example, on the peripheral wall 140. This feature may foreclose the need for an end user (e.g., technician) to run extensive wiring or cable to operate the device. Instead, pluggable cable connections may be used to connect the load circuit 116 to the load control 118 and load 120 in order to connect the signal 114 to these devices.

Feedback from sensors 166 may be useful to maintain or vary the pressure drop across the flow control 106. The sensors 166 may be disposed in the flow of material 104, on the flow control 106, or elsewhere as desired. Preferably, feedback monitors flow parameters upstream and downstream of the flow control 106. In turn, the load circuit 116 may process these signals to adjust the system to maintain the pressure drop or increase or decrease the pressure drop as necessary.

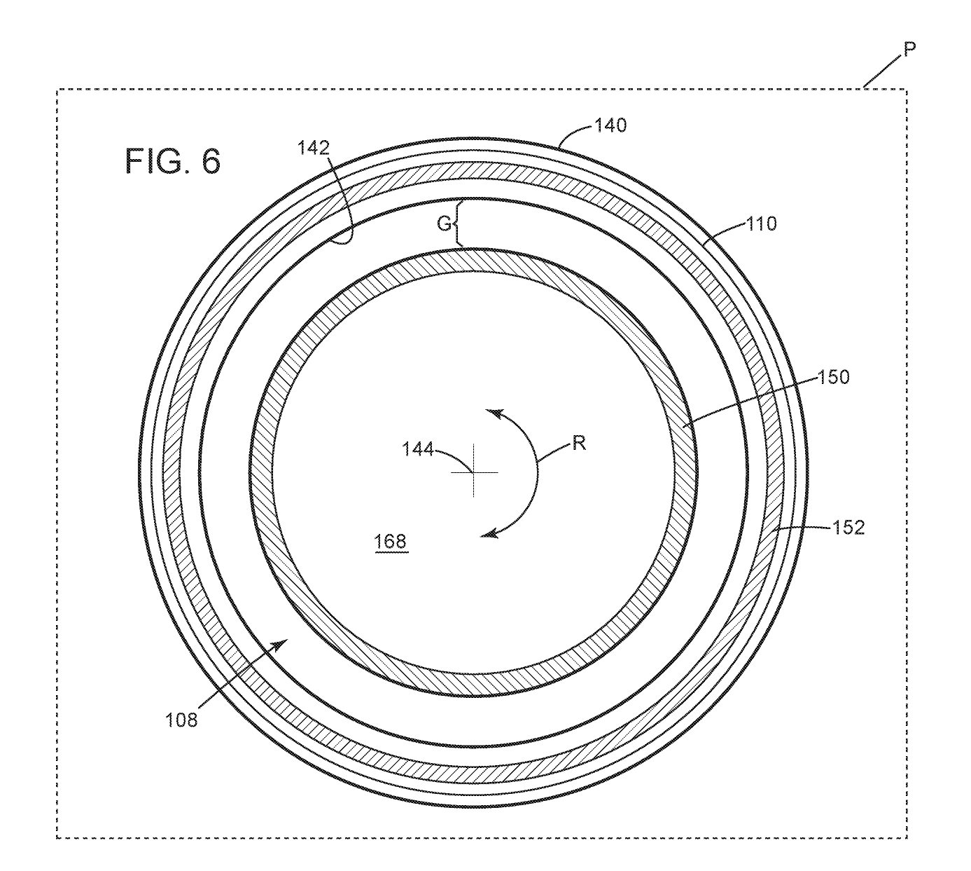

FIG. 6 depicts an elevation view of the cross-section of FIG. 5 along a plane P to show some exemplary structure for the flow modulator 100. Some parts like the load circuit 116 are removed for clarity. The plane P may penetrate the pipe section 140 perpendicularly to the axis 144 so as to reside effectively perpendicular to flow of material through the bore 142. The first component 108 may comprise a rotary or rotatable member 168. This design may align with the axis 144 and rotate in response to flow of material 104, as shown by the arrow R. The regions 154, 156 may align on the plane P, assuming annular geometry that may circumscribe the axis 144 in whole or in part. This geometry may define the general layout of the regions 154, 156 so as to take advantage of the annular structure of the peripheral wall 140. It may be required that the excitable region 156 is set in from the interior surface of the bore 142 simply to maintain structural integrity of the peripheral wall 140 to retain fluid. But there may be opportunities that the parts of the excitable region 156 make up or form portions of this interior surface and are, thus, exposed to material 104.

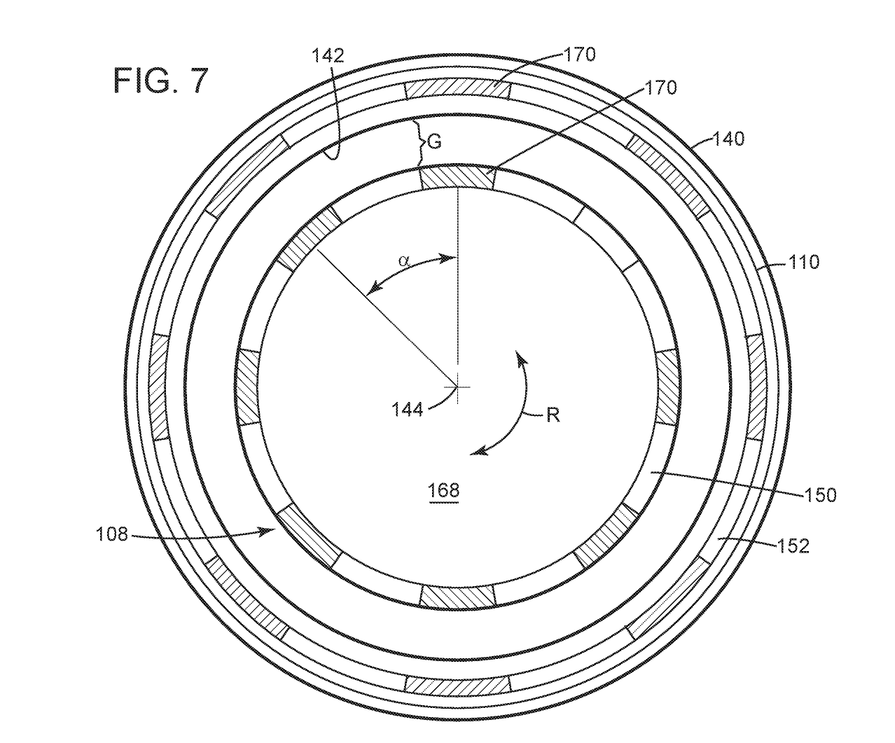

FIG. 7 depicts, schematically, an example of the elevation view of FIG. 6. The regions 154, 156 may assume small annular portions 170, each covering an annular area or having an arc length that is less than the diameter (or like dimension) of the peripheral wall 140. The portions 170 may disperse circumferentially in a pattern, for example, the circular pattern about the axis 144. This circular pattern may define discrete positions for the annular portions 170, often where the positions separate annular portions 170 adjacent to one another by an annular offset α. Values for the annular offset α may vary depending on structure of the parts and pieces of the design. However, preference may be given to values that optimize the regions 154, 156 to maximize the value of the signal 114, for example, to maximize power output of the flow modulator 100.

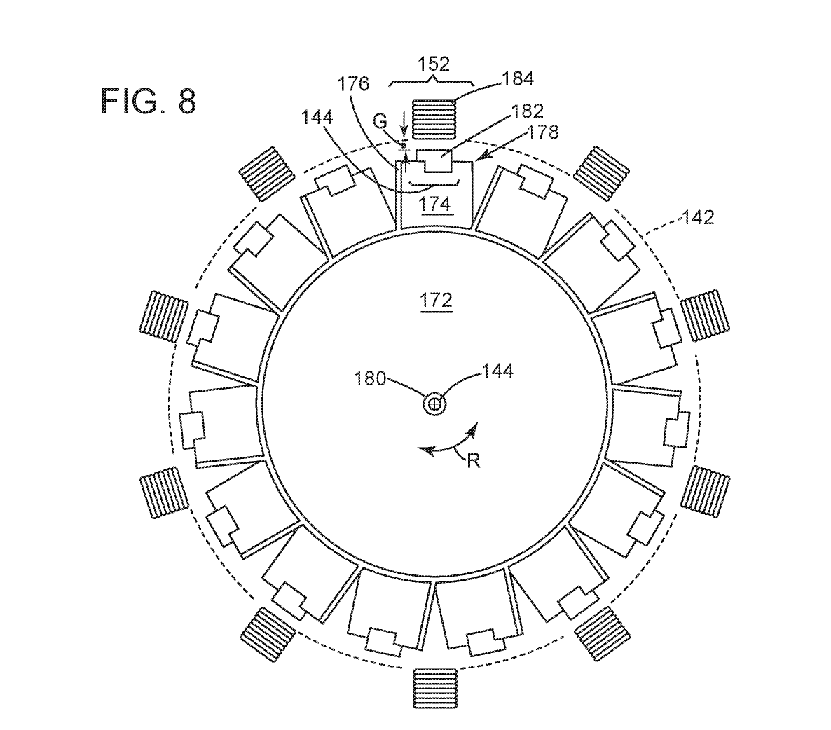

FIG. 8 depicts an elevation view of exemplary structure for use with the flow modulator 100 of FIG. 5. The rotary member 168 may form a turbine or turbine wheel with a central core 172 that supports extensible members 174, each preferably forming a blade 176 that extends radially toward the peripheral wall 140 to terminate at an end 178. At its center, the central core 172 includes a central support 180 to accommodate a shaft, bearings, or like elements that will facilitate rotation R. Magnets 182 may be disposed on the end 178 of the blade 176. Coils 184 may embed within the peripheral wall 140. The coils 184 may embody a winding of metal wire or conductive material. The parts 182, 184 may align on the plane P (FIG. 6) and form the annular portions 170 of regions 154, 156, respectively. In use, the magnets 182 generate a magnetic field (e.g., field 158). Proximity of the magnetic field may induce current in the coils 184. This current may form the signal 114. Preference may be given to construction that best exposes the coils 184 to interact with the magnetic field. As noted above, the load control 120 can impede rotation of the rotary member turbine wheel by varying load across the coils 184. The load control 120 may be configured, for example, to connect or disconnect individual coils 184, increase the load on individual coils 184, or apply power (e.g., signal 124) to individual coils 184, as desired.

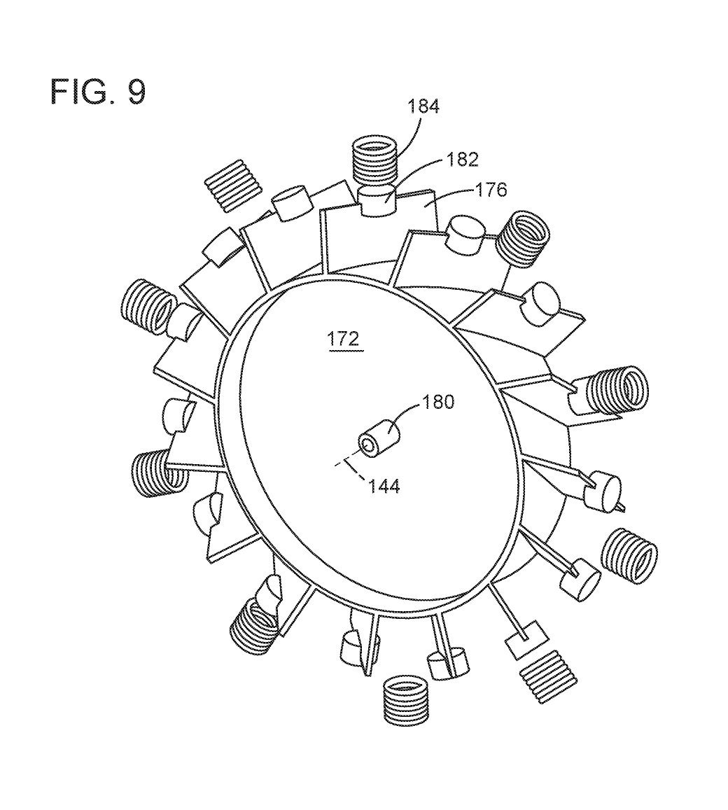

FIG. 9 depicts a perspective view of the structure of FIG. 8. References to the peripheral wall 140 are removed for clarity here. As shown, the blades 176 may adopt geometry that is aerodynamic, like an airfoil. This geometry may prove useful so that flow of material 104 over the blades 176 will appropriately generate rotation rotate R or “spin” the turbine wheel with limited resistance. Magnets 182 may affix as disc-like elements to the prevailing outer edge of the airfoil. However, in some implementations, the airfoils may incorporate materials that can generate the appropriate magnetic field at its edge.

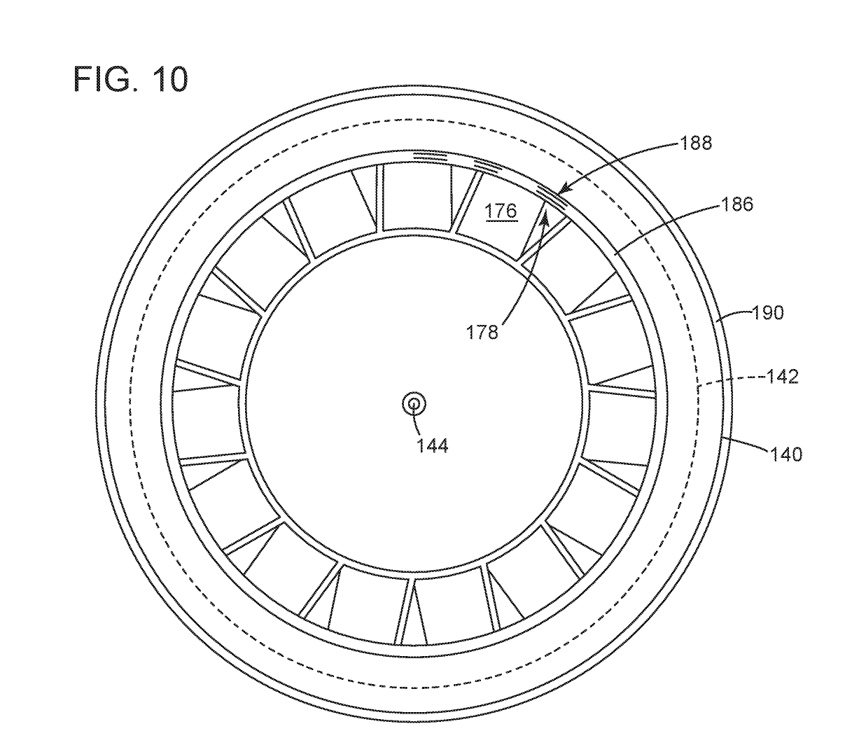

FIG. 10 depicts an elevation view of exemplary structure for use with the flow modulator 100 of FIG. 5. In this structure, the rotary member 168 may include an annular ring 186 that couples at the end 178 of blades 176 in lieu of magnets 182 (FIGS. 8 and 9). The annular ring 186 may include multiple layers 188, preferably comprising conductive materials. A winding 190 may circumscribe the axis 144 at the peripheral wall 140. The winding 190 may comprise one or more conductive wires that can carry current, e.g., signals 114, 124.

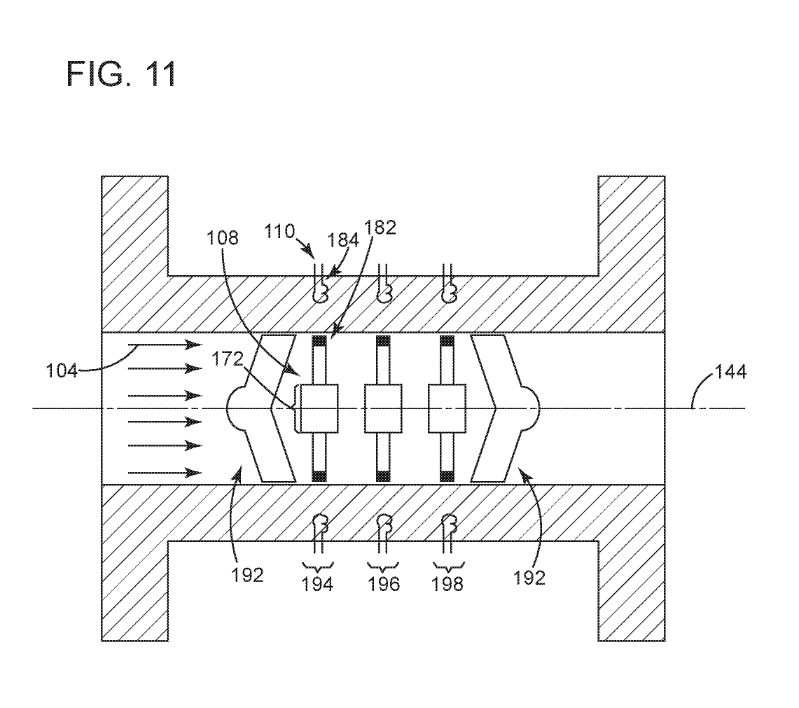

FIG. 11 depicts an elevation view of the cross-section of the side of another example of the flow modulator 100 of FIG. 5. This example includes one or more flow adjusters 192 that mount in the bore 142. The flow adjusters 192 may adopt geometry to influence characteristics of flow for material 104. Exemplary geometry, for example, may eliminate vortices or like perturbations so that the flow of material 104 is smooth or laminar in nature. This feature may maximize operation of the flow modulator 100. As also shown, between the adjusters 192, the device may leverage one or more stages (e.g., a first stage 194, a second stage 196, and a third stage 198). The stages 194, 196, 198 may comprise parts 108, 112, for example, the rotary member 168 with magnets 182 and corresponding coils 184. This arrangement may increase or multiply power output of the flow modulator 100, as desired. In one implementation, the rotary member 168 of the second stage 196 may rotate oppositely of the stages 194, 198. It is also possible for the load control 120 to vary load at the stages 194, 196, 198, individually so as to manage pressure drop across the device.

In light of the foregoing discussion, the improvements herein enable devices that can both generate pressure differential and harvest energy. These devices may be useful in remote locations or other installations, where power is scarce or unavailable, but where kinetic energy of flowing materials may provide an effective catalyst for operative devices that can perform these functions. For the oil & gas industry, the option to employ devices with this dual functionality is important, for example, to supplement power (either directly or by energy storage) for use on gas meters and metrology hardware. The “extra” power may allow for increased functionality because metrology hardware has historical limitations based entirely on power available at or in proximity to the installation. The flow modulator discussed here may serve future data transmission demands like real-time data transmission, which may require almost-continuous supply of reliable power on the device. In turn, the gas meter may operate as part of a Supervisory Control And Data Acquisition (SCADA) system, cloud-connected product life-cycle management software, and the “connected” that can monitor ongoing device health or diagnostics, and provide efficient allocation of resources to resolve potential issues in the field.

This written description uses examples to disclose the invention, including the best mode, and also to enable any person skilled in the art to practice the invention, including making and using any devices or systems and performing any incorporated methods. An element or function recited in the singular and proceeded with the word “a” or “an” should be understood as not excluding plural said elements or functions, unless such exclusion is explicitly recited. References to “one embodiment” of the claimed invention should not be interpreted as excluding the existence of additional embodiments that also incorporate the recited features. Furthermore, the claims are but some examples that define the patentable scope of the invention. This scope may include and contemplate other examples that occur to those skilled in the art. Such other examples are intended to be within the scope of the claims if they have structural elements that do not differ from the literal language of the claims, or if they include equivalent structural elements with insubstantial differences from the literal language of the claims.

Examples appear below that include certain elements or clauses one or more of which may be combined with other elements and clauses to describe embodiments contemplated within the scope and spirit of this disclosure.

1. An apparatus, comprising:
a pipe section have a peripheral wall forming a bore and flanges on either end;
a flow control disposed on the pipe section, the flow control comprising a first part and a second part, the first part disposed in the bore and the second part coupled with the peripheral wall to remain stationary relative to the first part, the second part forming a plurality of conductive regions, each spaced apart from adjacent conductive regions and disposed circumferentially about the first part on a plane perpendicular to the bore, the first part comprising at least two stages spaced axially from one another along the bore, each stage configured to generate a plurality of individual magnetic fields to stimulate the conductive regions to generate an electrical signal.

2. The apparatus of claim 1, wherein, at each stage, the plurality of individual magnetic fields are spaced annularly apart from one another.

3. The apparatus of claim 1, wherein the first part rotates the plurality of individual magnetic fields in response to the flow of fluid through the bore.

4. The apparatus of claim 1, wherein the bore has a uniform diameter throughout, and wherein the first part is separated from the bore by an annular gap that creates space between peripheral ends of the first part that generate the plurality of individual magnetic fields and the bore.

5. The apparatus of claim 1, further comprising:
a load control having circuitry to adjust an electrical load on the second part that sets mechanical resistance to movement of the first part.

6. A pressure regulator, comprising:
a pipe section with a bore having an axis;
wound coils of wire spaced apart circumferentially from adjacent coils of wire in a circular pattern that circumscribes the axis;
a turbine disposed inside the circular pattern of wound coils of wire, the turbine comprising at least two stages spaced axially from one another along the bore, each of the at least two stages having a plurality of individual blades spaced annularly apart from one another, each of the plurality of individuals blades terminating at an end in proximity to the wound coils; and
a magnet disposed on the end of each of the plurality of individual blades so as to align with the wound coils of wire.

7. The pressure regulator of claim 6, wherein the wound coils of wire are disposed in the peripheral wall.

8. The pressure regulator of claim 6, wherein the stages of the turbine rotate in response to flow of fluid at a rate that corresponds with a magnitude of an electrical signal induced in the wound coils of wire.

9. (canceled)

10. The pressure regulator of claim 6, wherein the wound coils of wire are separated from the magnets.

11. The pressure regulator of claim 6, further comprising:
an electrical load coupled with the wound coils of wire.

12. The pressure regulator of claim 6, further comprising:
circuitry to adjust electrical current in the wound coils of wire.

13. A method, comprising:
creating mechanical resistance to flow of fluid in a conduit by,
flowing the fluid through a turbine having at least two stages spaced axially apart from each other along the flow of fluid;
applying a load to wound coils of wire in proximity to both of the at least two stages of the turbine, the wound coils of wire spaced apart circumferentially from adjacent coils of wire in a circular pattern around the turbine and proximate the flow of fluid;
generating a plurality of individual magnetic fields from both of the at least two stages of the turbine in the flow of fluid; and
using the plurality of individual magnetic fields, inducing current in the wound coils in response to flow of the fluid.

14. The method of claim 13, further comprising:
adjusting the load in response to pressure upstream and downstream of the magnetic field.

15. The method of claim 13, further comprising:
using sensors disposed upstream and downstream of the magnetic field to set mechanical resistance in order to obtain a desired pressure drop.

16. The method of claim 13, further comprising:
setting the load to change pressure drop from upstream to downstream of the magnetic field.

17. The method of claim 13, further comprising:
rotating the plurality of individual magnetic fields in response to the flow of fluid.

18. The method of claim 13, further comprising:
using blades of a turbine disposed in the flow of fluid to rotate the plurality of individual magnetic fields.

19. The method of claim 13, further comprising:
annularly separating the wound coils on a pipe section that carries the flow of fluid.

20. The method of claim 13, further comprising:
directing the current to a gas meter.

21. The pressure regulator of claim 6, further comprising:
flow adjustors disposed in the bore upstream and downstream of the stages.
